(19) United States
(12) Patent Application Publication
(10) Pub. No.: US 2011/0285859 A1
(43) Pub. Date: Nov. 24, 2011

(54) COMMUNICATION IMAGE INTEGRATION MODULE

(75) Inventors: Chih-Chung Lin, Taipei City (TW); Chiu-Huang Sung, Zhonghe City (TW); Ching-Feng Hsieh, Taipei City (TW)

(73) Assignee: ASKEY COMPUTER CORP., TAIPEI (TW)

(21) Appl. No.: 12/838,590

(22) Filed: Jul. 19, 2010

(30) Foreign Application Priority Data
May 21, 2010 (TW) 099116323

(51) Int. Cl. H04N 5/225; H04B 7/00

(52) U.S. Cl. 348/207.1; 455/41.2; 348/E05.048

(57) ABSTRACT

A communication image integration module applied to a portable computer has both communication transmission and image capture functions, and the communication image integration module is connected to the portable computer through the electric connection interface unit, and the integration module includes a substrate, an image capture unit, a communication connection unit and a Bluetooth communication unit, and the image capture unit, the communication connection unit and the Bluetooth communication unit are installed on the substrate, and the image capture unit is electrically coupled to the electric connection interface unit, and the communication connection unit and the Bluetooth communication unit include a communication antenna and a Bluetooth antenna respectively, such that the communication image integration module can achieve primary manufacture, testing and purchase, and lower the manufacturing cost.

### CROSS-REFERENCE TO RELATED APPLICATION

This non-provisional application claims priority under 35 U.S.C. §119(a) on Patent Application No(s).099116323 filed in Taiwan, R.O.C. on May 21, 2010, the entire contents of which are hereby incorporated by reference.

### FIELD OF THE TECHNOLOGY

The present invention relates to a communication image integration module, in particular to a communication image integration module having a communication transmission unit and an image capture unit at the same time.

### BACKGROUND

To achieve the lightweight and portability of a portable computer, an all-in-one design is adopted for integrating various different chips onto a motherboard. However, the chips are provided by different suppliers, so that it is necessary to perform a circuit layout each time for developing a new product in order to achieve the compatibility of the chips in the portable computer and prevent interferences among the chips.

To overcome the aforementioned circuit layout issue, an electronic device with a USB interface as disclosed in R.O.C. Pat. No. M360475 is assembled with the plug-and-play feature of the USB for reducing the troublesome of the circuit design. However, the patented technology can lower the level of difficulty of the circuit design, but the present portable computer comes with many built-in functions (such as the wireless networking function) to meet the user requirements, and no longer requires an additional installation of USB electronic devices with the aforementioned functions for an expansion. In general, the functions of a USB device are provided by different designers or manufacturers, and thus only one function (such as the wireless transmission circuit module) of the USB device can be used. If users need different functions, then the portable computer must provide many USB ports for inserting and using the USB device. According to present commonly used wireless communication standards such as WIFI, Bluetooth and WiMAX, at least three USB ports must be added and such application is very inconvenient.

### SUMMARY

It is a primary objective of the present invention to provide a communication image integration module having an image capture unit, a communication connection unit and a Bluetooth communication unit installed on a substrate and provided for the application of a portable computer.

Another objective of the present invention is to provide a communication image integration module which is a Bluetooth communication unit having at least two types of wireless communication transmission units and an image capture unit.

To achieve the foregoing and other objectives, the present invention provides a communication image integration module applied to a portable computer, and comprising a substrate, an image capture unit, a communication connection unit and a Bluetooth communication unit. The substrate includes an electric connection interface unit, and the substrate is connected to the portable computer through the electric connection interface unit. The image capture unit is installed on the substrate and electrically coupled to the electric connection interface unit. The communication connection unit is installed at the substrate and includes a communication antenna. The Bluetooth communication unit is installed at the substrate and includes a Bluetooth antenna.

Compared with the prior art, the present invention provides an integrated communication image module, such that the integrated communication image module provides both communication transmission and image capture functions to a portable computer through an electric connection interface unit, wherein the communication transmission comes with tow or more wireless communication transmission standards, and at least one of the wireless communication transmission standards is the Bluetooth communication standard, so that the present invention can achieve primary manufacture, testing and purchase, lower the manufacturing cost and reduce the area of a printed circuit board required for a circuit layout of the portable computer.

### BRIEF DESCRIPTION OF THE DRAWINGS

FIG. 1 is a schematic view of a communication image integration module in accordance with a first preferred embodiment of the present invention;

FIG. 2 is a schematic view of a communication image integration module in accordance with a second preferred embodiment of the present invention; and

FIG. 3 is a schematic view of a communication image integration module in accordance with a third preferred embodiment of the present invention.

### DETAILED DESCRIPTION

The objects, characteristics and effects of the present invention will become apparent with the detailed description of the preferred embodiments and the illustration of related drawings as follows.

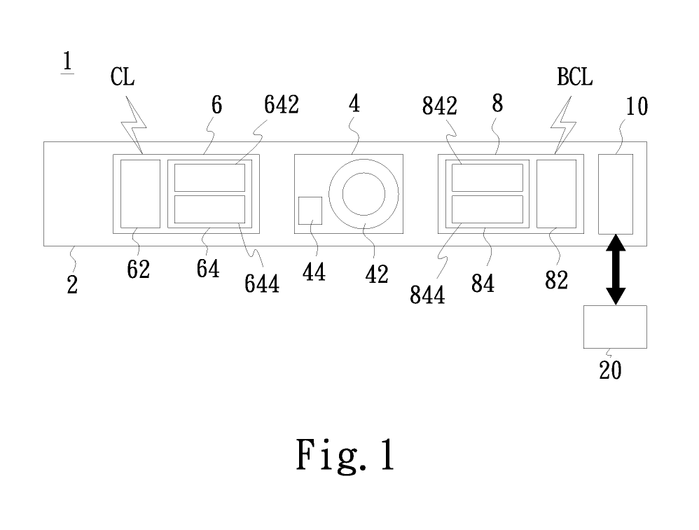

With reference to FIG. 1 for a schematic view of a communication image integration module in accordance with a first preferred embodiment of the present invention, the communication image integration module 1 comprises a substrate 2, an image capture unit 4, a communication connection unit 6 and a Bluetooth communication unit 8. The substrate 2 includes an electric connection interface unit 10 for connecting a circuit module 20, wherein the electric connection interface unit 10 is one selected from the collection of USB, PCI Express, Mini-PCI, External SATA, SATA and FIRE WIRE, and the circuit module 20 is a circuit of a motherboard. The image capture unit 4 is installed at the substrate 2. In general, the image capture unit 4 is provided for capturing an external image, and the electric connection interface unit 10 is provided for transmitting the image to the circuit module 20. The image capture unit 4 includes an optical component 42 and a video chip 44, and the video chip 44 is provided for capturing the image through the optical component 42. In addition, the video chip 4 can be a charge coupling device (CCD) chip, a complementary metal oxide semiconductor (CMOS) chip or a combination of the above. The communication connection unit 6 is also installed at the substrate 2, and the communication connection unit 6 includes a communication antenna 62 provided for the communication image integration module 2 to perform a communication connection CL, and a wireless communication method is adopted for transmitting data, image or control signals, such that the circuit module 20 can perform two-way wireless communications outside the communication image integration module 1 through the communication antenna 62 of the communication connection unit 6 installed on the substrate 2, wherein the communication connection unit 6 has a wireless transmission standard selected from the collection of Wireless Fidelity (WIFI, Zigbee), Wireless Area Network Standard (IEEE 802.11, IEEE 802.16, IEEE 802.15.4), Worldwide Interoperability for Microwave Access (WIMAX), Code Division Multiple Access (CDMA), wideband Code Division Multiple Access (WCDMA), Global System for Mobile Communications (GSM), High Speed Data Packet Access (HSDPA), High Speed Uplink Packet access (HSUPA), Bluetooth and Ultra Wide Band (UWB). In addition, the communication connection unit 6 comprises a communication chip 64 having a transmitting terminal 642 and a receiving terminal 644, and the communication connection unit 6 is electrically coupled to the communication antenna 62. In the meantime, the communication antenna 62 is installed and attached closely onto the substrate 2 or not installed on the substrate 2. For example, the communication antenna 62 is laid and attached closely onto the substrate 2 by means of micro strip lines or the communication antenna 62 is connected to the communication chip 64 by a floating method. The Bluetooth communication unit 8 is installed at the substrate 2, and the Bluetooth communication unit 8 includes a Bluetooth antenna 82 provided for the communication image integration module 1 to perform a Bluetooth communication connection BCL, wherein the Bluetooth communication unit BCL includes a Bluetooth communication chip 84 having a Bluetooth transmitting terminal 842 and a Bluetooth receiving terminal 844, and the Bluetooth communication unit BCL is electrically coupled to the Bluetooth antenna 82, and the Bluetooth antenna 84 is installed and attached closely onto the substrate 2 or not installed on the substrate 2. The communication image integration module 1 is electrically coupled to the circuit module 20 to provide a modular design effectively, so as to lower the manufacturing cost and reduce the area of the printed circuit board required for the circuit layout of the circuit module 20 effectively.

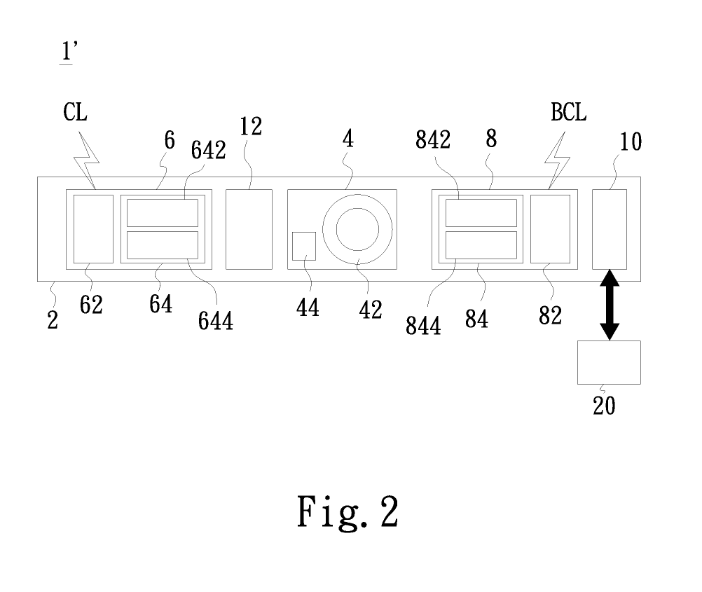

With reference to FIG. 2 for a schematic view of a communication image integration module in accordance with a second preferred embodiment of the present invention, the communication image integration module 1′ further comprises an adjustable voltage unit 12 in addition to the substrate 2, image capture unit 4, communication connection unit 6 and Bluetooth communication unit 8 and the adjustable voltage unit 12 is also installed n the substrate 2, and the adjustable voltage unit 12 is electrically coupled to the image capture unit 4, the communication connection unit 6 and the Bluetooth communication unit 8, and the adjustable voltage unit 12 is provided for driving the image capture unit 4, the communication connection unit 6 and the Bluetooth communication unit 8, wherein the adjustable voltage unit 12 can supply electric power of different voltage levels to the image capture unit 4, the communication connection unit 6 and the Bluetooth communication unit 8. It is noteworthy to point out that the adjustable voltage unit 12 simultaneously supplies power to the image capture unit 4, the communication connection unit 6 and the Bluetooth communication unit 8. Unlike the prior art, the invention needs not to supply power from different voltage units to the image capture unit 4, the communication connection unit 6 and the Bluetooth communication unit 8, so as to greatly reduce the components for supplying power and the area of laying out the electric power lines.

In another preferred embodiment, the voltage required for driving the image capture unit 4, the communication connection unit 6 and the Bluetooth communication unit 8 can receive the required voltage through an external power supply (not shown in the figure) of the communication image integration module 1 or through the electric connection interface unit 10, such as a USB interface can supply a voltage of approximately 5 volts.

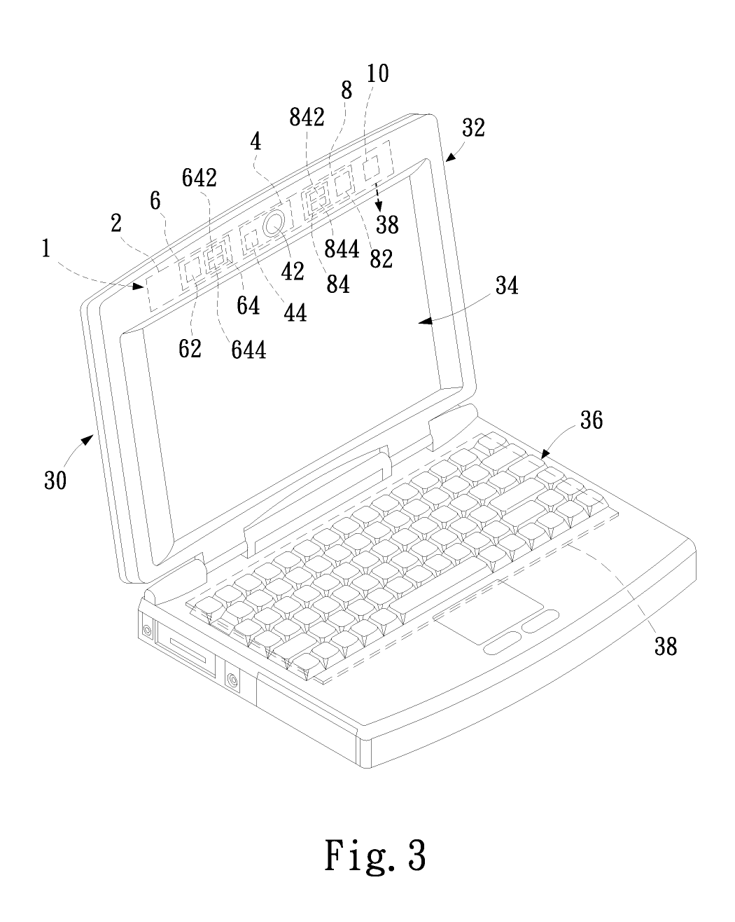

With reference to FIG. 3 for a schematic view of a communication image integration module in accordance with a third preferred embodiment of the present invention, the communication image integration module 1 is embedded in a portable computer 30, and the portable computer 30 comprises a casing 32, a screen 34, a keyboard 36 and a motherboard 38, wherein the casing 32 is provided for covering the communication image integration module 1 and motherboard 38, and in particularly, the communication image integration module 1 is installed at a position adjacent to the periphery of the screen 34 of the portable computer 30. In this preferred embodiment, the communication image integration module 1 is installed at the top of the screen 34. The communication image integration module 1 comprises a substrate 2, an image capture unit 4, a communication connection unit 6 and a Bluetooth communication unit 8, and the communication image integration module 1 is electrically coupled to the motherboard 38 through an electric connection interface unit 10 of the substrate 2, such that the motherboard 38 can be connected by the communication image integration module 1 for a Bluetooth communication connection and an image capture, without the need of designing the image capture unit 4, communication connection unit 6 and Bluetooth communication unit 8 again for each time of designing the portable computer. Besides the communication image integration module 1 reduces the design time, the communication image integration module 1 can be purchased or used directly by downstream system manufacturers. Since the communication image integration module 1 is installed on a side of the screen 34, better communication and Bluetooth communication connection can be provided effectively. Since the communication connection unit 6 and the Bluetooth communication unit 8 are installed at both ends of the substrate 2, the issue of electromagnetic interference can be overcome more effectively.

Compared with the prior art, the present invention provides an integrated communication image module, and the integrated communication image module is capable of providing the communication transmission and image capture functions to a portable computer through the electric connection interface unit, wherein the communication transmission includes two ore more wireless communication transmission standards, and at least one of the wireless communication transmission standards is a Bluetooth communication standard, and thus the present invention can greatly reduce the manufacturing cost and the area of the printed circuit board for the circuit layout of the portable computer, in addition to the primary manufacture, testing and purchase.

While the invention has been described by means of specific embodiments, numerous modifications and variations could be made thereto by those skilled in the art without departing from the scope and spirit of the invention set forth in the claims.

What is claimed is:

1. A communication image integration module, applied to a portable computer, and comprising:
a substrate, having an electric connection interface unit, and coupled to the portable computer through the electric connection interface unit;
an image capture unit, installed on the substrate, and electrically coupled to the electric connection interface unit;
a communication connection unit, installed at the substrate, and having a communication antenna; and
a Bluetooth communication unit, installed at the substrate, and having a Bluetooth antenna.

2. The communication image integration module of claim 1, wherein the image capture unit comprises an optical component and a video chip, and the video chip is provided for capturing the image through the optical component.

3. The communication image integration module of claim 2, wherein the video chip is a charge coupling device (CCD) chip, a complementary metal oxide semiconductor (CMOS) chip, or a combination of the above.

4. The communication image integration module of claim 1, wherein the communication connection unit comprises a communication chip including a transmitting terminal and a receiving terminal, and the communication connection unit is electrically coupled to the communication antenna.

5. The communication image integration module of claim 4, wherein the communication connection unit has a communication standard selected from the collection of WIFI, IEEE 802.11, IEEE 802.16, WIMAX, CDMA, WCDMA, GSM, HSDPA, HSUPA, Bluetooth, UWB and IEEE 802.15.4 (Zigbee).

6. The communication image integration module of claim 1, wherein the Bluetooth communication unit comprises a Bluetooth communication chip including a Bluetooth transmitting terminal and a Bluetooth receiving terminal, and the Bluetooth communication unit is electrically coupled to the Bluetooth antenna.

7. The communication image integration module of claim 1, wherein at least one of the communication antenna and Bluetooth antenna is installed and attached closely onto the substrate.

8. The communication image integration module of claim 1, further comprising an adjustable voltage unit electrically coupled to the image capture unit, the communication connection unit and the Bluetooth communication unit, and provided for driving the image capture unit, the communication connection unit and the Bluetooth communication unit.

9. The communication image integration module of claim 1, wherein the electric connection interface unit is one selected from the collection of USB, PCI Express, Mini-PCI, External SATA, SATA and FIRE WIRE.
